(19) United States
(12) Patent Application Publication
(10) Pub. No.: US 2009/0127144 A1
(43) Pub. Date: May 21, 2009

(54) Device for Storing and Transporting Data Carriers

(76) Inventor: Josef Krummenacher, Muri (CH)

Correspondence Address: THE WEBB LAW FIRM, P.C., 700 KOPPERS BUILDING, 436 SEVENTH AVENUE, PITTSBURGH, PA, 15219, US

(21) Appl. No.: 11/884,396

(22) PCT Filed: Feb. 13, 2006
(86) PCT No.: PCT/CH06/00094

§ 371 Date: Feb. 26, 2008

(30) Foreign Application Priority Data
Feb. 15, 2005 (CH) 263/05

(51) Int. Cl. G11B 25/04; B65D 85/57

(52) U.S. Cl. 206/308.2; 206/308.1

(57) ABSTRACT

The invention relates to a fastening device for at least one circular data carrier such as a CD or DVD with a central opening in a cassette or box. The fastening device of this type prevents an unauthorized removal of the data carrier when the container is closed by virtue of the fact that a safeguarding device is provided that has a supporting ring concentric to a bearing ring of the box and facing the data carrier. The safeguarding device is fastened inside the box such that when the box is closed, the safeguarding device at least partially covers the area of tongues of the box on the top side of the fastening device, and that the supporting ring is arranged on the side of the data carrier facing away from the bearing ring.

### TECHNICAL FIELD

The present invention relates to a fastening device for at least one circular data carrier, such as for example a CD or DVD, with a central opening in a cassette or box. The box comprises, on a bottom part, a middle part, to which there are fastened at least two tongues, with preference a ring of tongues, which resiliently engage in the central opening of the at least one data carrier. Furthermore, the middle part comprises, on the radial outer side, a bearing ring, which encircles at least in sections and upon which the data carrier rests.

### PRIOR ART

Digital, optically readable data carriers such as CDs or DVDs are normally placed in flat cassettes or boxes for storage, typically being held by a corresponding securing device through their central opening. To assist the securement by means of the central opening, further enclosing or even gripping means may be provided at the edge of the data carrier.

As far as music CDs are concerned, hard boxes, for example made of PC or PS, are typically used, and these are scarcely flexible and scarcely any larger than the data carrier. As far as DVDs are concerned, which are sold in larger containers, for one reason because of the booklets that are often supplied with the data carrier, boxes that are comparatively flexible and larger in surface area, which are produced for example from PP, are generally provided. They have a bottom half-part and a lid half-part, which are connected to each other by means of a simple hinge running along one long edge of the box and taking the form of a thinning of the material.

The data carrier is likewise held in such a container by a device which reaches through the central opening of the data carrier and takes the form for example of a ring or a pair of tongues. The data carrier can be removed from such a securement by the tongues being deflected from an upper position downward under pressure applied by the thumb, and thereby made to tilt down out of the central opening. Such a construction is disclosed for example in WO-A-97/41563.

When a ring of tongues is used for the central securement, this ring is likewise pressed downward by pressure applied with the thumb, the individual tongues then being made to tilt substantially inward and so releasing the central opening of the data carrier. Such constructions are described for example in the documents WO-A-03/094168 and EP-A-1429337.

To guard against theft, so-called tags, that is to say electronically detectable adhesive elements that can be identified by means of an antenna at the exit, are normally provided on such containers on the outer side, or in the lid or on the bottom, and can be used appropriately to establish unauthorized removal of the container from the store (so-called RFID tags). Alternatively, it is possible to push the entire container into a grid-like receiving container on which such a tag is provided and to remove this grid-like receiving container when a sale is made. The latter solution is particularly inelegant and is therefore not generally preferred.

A problem with such containers in the case where tags are provided on the container or in the container, in particular because of the comparatively soft material that is used, is that it is possible to remove the data carrier from such a container and steal it from a store without removing the container from the store. This is possible for example by, in a first step, exerting a pressure on the large area of the container in the region of the central securing device for the data carrier, through the entire container, which releases the data carrier from the securement. After this first step, the data carrier is loose in the container. In a second step, the container can then be pressed together along its opening edge, so that there forms at the lower edge a gap through which the data carrier can be made to fall downward out of the container. This can scarcely be prevented by, for example, the entire container being sealed in a cellophane film, since professional thieves easily slit this open with a fine knife cut in the region of the gap before the second step.

It is correspondingly easily possible with such containers to remove the data carrier from the container and consequently steal the object of actual interest without removing the container protected by antitheft measures from the store.

There are already documents concerned with this problem, such as for example WO-A-02/31831, which proposes in conjunction with a securing device according to WO-A-97/41563 pushing a security device under the pair of tongues, so that the tongues can no longer be deflected downward. The first step is allegedly prevented by this measure, that is to say it is no longer possible to remove the data carrier from the securing device by pressure on the large area of the container, since the tongues can no longer be pressed out downward from the opening of the DVD as long as the security device is present in the container.

An alternative solution in conjunction with the same securing device is described in WO 02/39451. Additionally provided here is the possibility of combining the security device with a strip- or bar-shaped element and arranging this in the container in such a way that this security device can be removed without opening the container before a sale is made. Here, too, the security device reaches under the pair of tongues and prevents the possibility of the tongues being deflected downward, and consequently the data carrier being removed, as long as the security device is present in the container.

A similar solution is provided in FR-A-2785439, in which a security device in the form of a security button is pushed into a ring of tongues from above in such a way that the tongues can no longer be deflected in relation to the central axis of the securing device.

### SUMMARY OF THE INVENTION

The invention is accordingly based on the object of providing an improved fastening device for a data carrier in a container, in particular an improved fastening device with regard to unauthorized removal of the data carrier, for example in a store. In particular, it concerns the improvement of a fastening device which is intended for at least one circular data carrier, such as a CD or DVD, with a central opening in a cassette or box, the box comprising, on a bottom part, a middle part, to which there are fastened at least two tongues, with preference a ring of at least 4 tongues, which resiliently engage in the central opening of the at least one data carrier, and, with preference, the middle part comprising, on the radial outer side or the bottom half-part, a bearing ring, which encircles at least in sections and upon which the data carrier rests.

This object is achieved by a security device, which comprises a supporting ring, supporting rib or supporting region, which is substantially concentric to the bearing ring, encircles at least in sections, or at least crosses with the bearing ring, and faces the data carrier, the security device being fastened in the box in such a way that, when the box is closed, it at least partially covers the region of the tongues on the upper side of the fastening device, and that the supporting ring or supporting region is arranged, at least in certain regions, on the side of the data carrier that is facing away from the bearing ring.

The essence of the invention is consequently to provide a security device, for example in disk form, which has a supporting ring which is arranged to a certain extent opposite the bearing ring, which is provided on the bottom part. It may be a supporting ring which is arranged concentrically in relation to the bearing ring. It may, however, also be a radiating arrangement of a number of supporting ribs, for example radial supporting ribs, which to a certain extent cross with the bearing ring (less sensitive with respect to centering than a concentric supporting ring), or any desired forms of ribs or supporting regions, as long as a sufficient number of locations or regions can transfer the force directly to the bearing ring.

If, in the presence of such a security device, a pressure is exerted on the central region of the data carrier when the box is closed, this pressure cannot act on the securing tongues, but is transferred substantially completely to the bearing ring. Unauthorized manipulation for the removal of a data carrier in spite of the container being closed, as explained at the beginning, can be prevented very effectively in this way, and it is possible to prevent absolutely any pressure from being exerted on the ring of tongues in the event of such a manipulation.

By contrast with devices which exclusively restrict the mobility of the tongues, and with which it is correspondingly possible under some circumstances for the tongues nevertheless to be deformed if sufficiently great force is applied, this is not possible in the case of the present fastening device, since no loading at all can be transferred to the tongues, but instead manipulative loading is transferred completely from the security device via the supporting ring to the bearing ring.

Such a fastening device may be formed for example by a central securement, as described in WO-A-03/094168 or in EP-A-0692791, in combination with a security device that is adapted to the respective bearing ring.

Purely for more precise explanation, it should be emphasized that a bearing ring is to be understood as meaning an annular, with preference encircling, rib which faces the data carrier from the underside of the latter. As explained further below, such a rib has with preference a height perpendicularly to the plane of the data carrier in the range of 1 to 4 mm. As likewise to be emphasized for more precise explanation, the bearing ring is normally formed in an encircling manner and, to be able to serve in the first place as a bearing ring, is arranged radially outside the tongues and radially inside the data region of the data carrier. With particular preference, the bearing ring has a radius of 20-30 mm.

The proposed construction is also distinguished by the fact that the data carrier is fastened in the fastening device, with the security device fitted, such that it is mounted in a substantially freely rotatable manner. In this way, the data carrier is optimally protected and there are no unnecessary pressure points or friction points.

It should likewise be emphasized for further, purely more precise explanation that a supporting ring is to be understood as meaning an annular, with preference encircling, rib which faces the data carrier from the upper side of the latter. Such a rib has with preference a height perpendicularly to the plane of the data carrier in the range of 1 to 4 mm, in particular in the range of 1.5-2.5 mm, as explained in detail further below. The supporting ring is correspondingly normally formed in an encircling manner and is arranged radially outside the tongues and radially inside the data region of the data carrier, in order to be able in the first place to serve as a supporting ring. It has with preference a radius of 20-30 mm.

It follows from this that the supporting ring and the bearing ring normally have substantially the same radius.

Preferably, the security device is in this case removably fastened in the box, and can for example be removed immediately after purchase in the store (typically, the box must be opened in any case to check its contents), or the security device may be removed when the box is opened for the first time by the customer.

Such a security device may be fastened to the lid part of the box, to a certain extent opposite the ring of tongues. Preferably, however, the security device is fastened at least indirectly to the bottom part in the region of the central opening of the data carrier and rests to a certain extent on the inserted data carrier from above. With preference, the security device has a region in the form of an annular disk, at the peripheral edge of which a downwardly directed, with particular preference encircling, supporting ring is fastened or integrally formed, and which has in its central region means by which the security device can be releasably fastened to the middle part. This releasable fastening may take the form for example of simple click-in-place mechanisms (ridge and groove, stud and socket, etc.).

According to a further preferred embodiment, a ring of tongues is arranged on the bottom part of the container, in the case of which the tongues fasten the data carrier by means of radially outwardly directed retaining lugs, and in the case of which the tongues can be made to tilt away radially inward by means of a central button for the removal of the data carrier. In this case, the means are releasably in engagement with portions of the tongues and/or of the button. The means preferably constitute a downwardly directed, cylindrical or conical region, which is made to click in place with portions of the tongues and/or of the button by means of a tongue and groove or channel and rib, it being particularly preferred for the security device to have a central opening within this cylindrical or conical region.

A further preferred embodiment is characterized in that the button has a substantially circular region, to be actuated by a finger, and a cylindrical or conical, downwardly directed (with preference conically downward-opening) connecting region, the lower edge of which is connected at least indirectly to the retaining lugs. The connecting region has with preference on its radially outwardly directed surface a, with particular preference encircling, retaining rib or retaining groove or retaining studs, and the security device has on its cylindrical or conical region corresponding, radially inwardly directed latching means, with preference in the form of a substantially encircling retaining rib and/or retaining groove and/or retaining studs.

The security device may in this case be formed simply as a device in the form of an annular disk, as a polygonal device or as a device of any desired form, but for easier removal it is preferably possible to arrange on the disk-shaped region a removal aid in the form for example of a tab or the like. With preference, this removal aid is flexible, so that it can be reached under with the fingers and the security device can be removed more easily.

The dimensioning of the region of the security device that is effective as a guard against theft is determined substantially by the diameter of the bearing ring of the bottom part. Since the possible diameter of the bearing ring is substantially determined by the maximum diameter of the data-free region of the data carrier, the outside diameter of the security device, at least of the supporting ring, is correspondingly likewise substantially determined by the diameter of the data-free region of the data carrier. The overall form of the device may even be polygonal, star-shaped or the like, as long as the supporting ring or the supporting ribs are adapted to the bearing ring. In the case of typical DVDs or CDs, the diameter of the data-free region is about 35 mm, and, correspondingly, the security device preferably comprises a region in the form of a disk with a diameter in the range of 15-40 mm, with preference in the range of 20-30 mm.

The security device is produced most simply in one piece from polystyrene, polypropylene or polycarbonate in a molding process; equally, it is preferred to produce the box from polystyrene, polypropylene or polycarbonate. While constructions according to the prior art (compare for example FR 2785439, US 2004/0020801, US 2002/0175097, WO 2004/093082 and the like) are normally produced from the hard material polystyrene, which under some circumstances can damage the data carrier but can be deformed less (and, correspondingly, the data carrier can also be removed less easily from the fastening device under the effect of force), the construction according to the invention is produced with preference from the soft material polypropylene. A fastening device or security device made of such a soft material is not in principle uncritical with respect to deformation, since the data carrier can under some circumstances be removed from the fastening device by the effect of force (impact, deformation of the box, etc.). However, the combination now proposed of the security device and the fastening device solves this inherent problem by allowing this soft material, which is optimum with respect to contacts with the data carrier, to be processed in a construction in which, in spite of the soft material, the data carrier cannot be removed from the fastening device even under the effect of force, on account of the clamping between the bearing ring and the supporting ring.

Added to that is the fact that constructions using polystyrene are normally designed such that, when the data carrier is removed, this data carrier is likewise intended to be at least partially deformed. On the other hand, when the soft material polyethylene is used, no deformation of the data carrier takes place during removal, but substantially only a deformation of the material of the fastening device (tongues) This is likewise less harmful to the data carrier.

If the security device is intended to be taken out of the box by the sales personnel before it is surrendered to the customer, and at the same time there is an antitheft means, for example of an electronic type, it is possible with preference to provide the security device with an antitheft means, with particular preference in the form of an RFID tag. This allows the use of high-quality RFID tags which do not have to be destroyed on purchase, to enable the customer to leave the sales outlet without setting off an alarm. Furthermore, the security devices can be reused as antitheft means.

Furthermore, the present invention relates to a security device for a fastening device such as that described above. This security device is characterized in that it has a region in the form of a circular disk or of a polygonal (rectangular etc.) star-shaped or similar kind with a diameter in the range of 15-40 mm, with preference in the range of 20-30 mm, at the peripheral edge of which a downwardly directed, with particular preference encircling, supporting ring with a height in the range of 1-4 mm, with preference of 1.5-2.5 mm, is integrally formed, and which has in its central region a downwardly directed, cylindrical or conical, with preference conically downward-tapering, region with a height in the range of 2-6 mm, which can be made to click in place with portions of the tongues and/or of the button by means of a tongue and groove or channel and rib or stud and socket. With preference, the security device may be designed in such a way that it has a central opening, through which the button of the fastening device at least partially passes.

A first preferred embodiment of the security device is characterized in that an encircling, radially inwardly directed latching lug is integrally formed on the conically downwardly tapering region, at the lower edge.

A further embodiment according to the invention is characterized in that a removal aid in the form of at least one removal tongue is provided, with preference of a flexible form and having a length in the range of 10-80 mm, with preference of 30-70 mm (respectively measured from the central axis of symmetry of the fastening device).

Furthermore, the present invention relates to a box for a fastening device such as that described further above, or a box for interaction with a security device such as that described above. Such a box is characterized in that a ring of tongues is arranged on a bottom half-part and with particular preference is formed in one piece with it, in the case of which ring the tongues fasten the data carrier by means of radially outwardly directed retaining lugs, and in the case of which the tongues can be made to tilt away radially inward by means of a central button for the removal of the data carrier, and in that the button has a (substantially circular) region, to be actuated by the thumb, and a cylindrical or conical, downwardly directed connecting region, the lower edge of which is connected at least indirectly to the retaining lugs, and in that the connecting region has on its radially outwardly directed surface a, with preference encircling, retaining rib or retaining groove, which is intended for entering into interaction with the security device in order to fasten the latter.

With preference, an encircling retaining rib is arranged on the radially outer surface of the connecting region.

The three elements, the entire fastening device, the security device and the box, relate to one another like a lock and key and can therefore only be formulated in combination or as individual elements in separate independent claims.

Last but not least, the present invention relates to a method for the secure protection of a data carrier such as a CD or DVD in a box, such as that described above, which is characterized in that, after inserting a data carrier, a security device such as that described above is placed on the ring of tongues and latched in place, that is to say releasably connected to the bottom half-part.

Further preferred embodiments of the invention are described in the dependent claims.

### BRIEF EXPLANATION OF THE FIGURES

The invention is to be explained in more detail below on the basis of exemplary embodiments in conjunction with the drawings, in which:

FIG. 1 shows views and sections of a first exemplary embodiment, a) showing a plan view of a DVD box without an inserted DVD without the lid half-part with the security button, b) showing a plan view of a security button; c) showing a section along A-A in FIG. 1b) with a surrounding box and with an inserted DVD, d) showing a section along B-B in FIG. 1b) with a surrounding box and with an inserted DVD; and e) showing a central section through a security button;

FIG. 2 shows views and sections of a second exemplary embodiment, a) showing a plan view of a DVD box without an inserted DVD without the lid half-part with the security button with a removal tab, and b) showing a plan view of a security button with a removal tab; and

FIG. 3 shows an axial partial section analogous to FIG. 1c) through a further exemplary embodiment.

### WAYS OF CARRYING OUT THE INVENTION

Some exemplary embodiments of the invention are to be discussed with the aid of the figures, these embodiments being intended to be used for explaining the invention and not for restricting the subject matter of the invention as it is formulated in the claims.

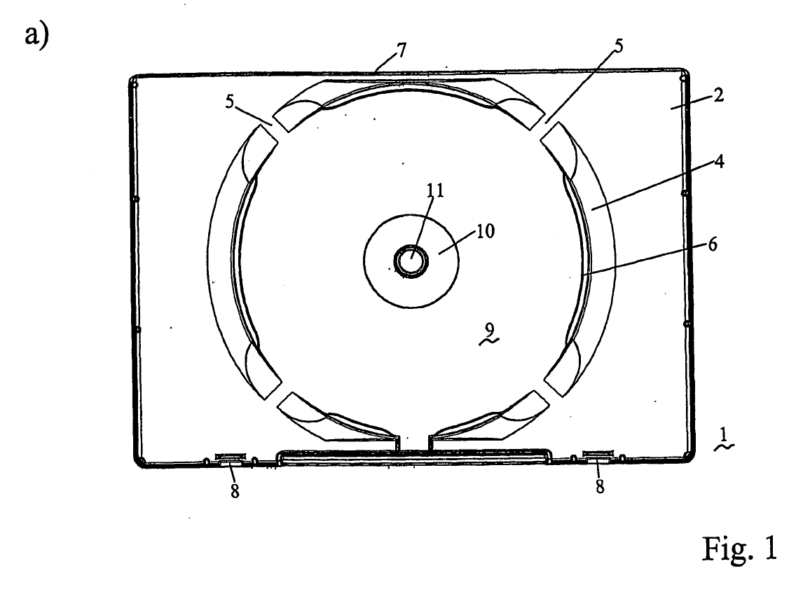

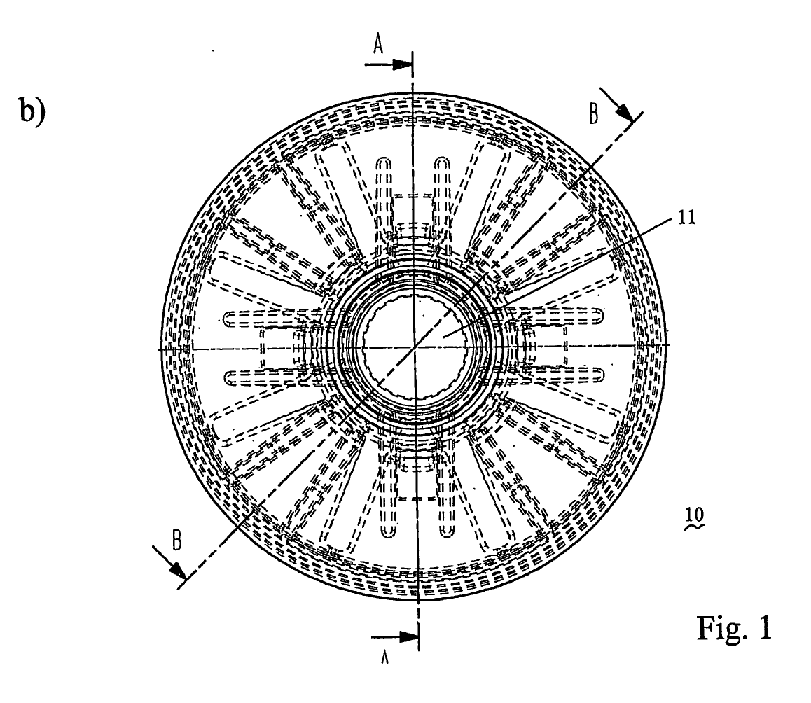

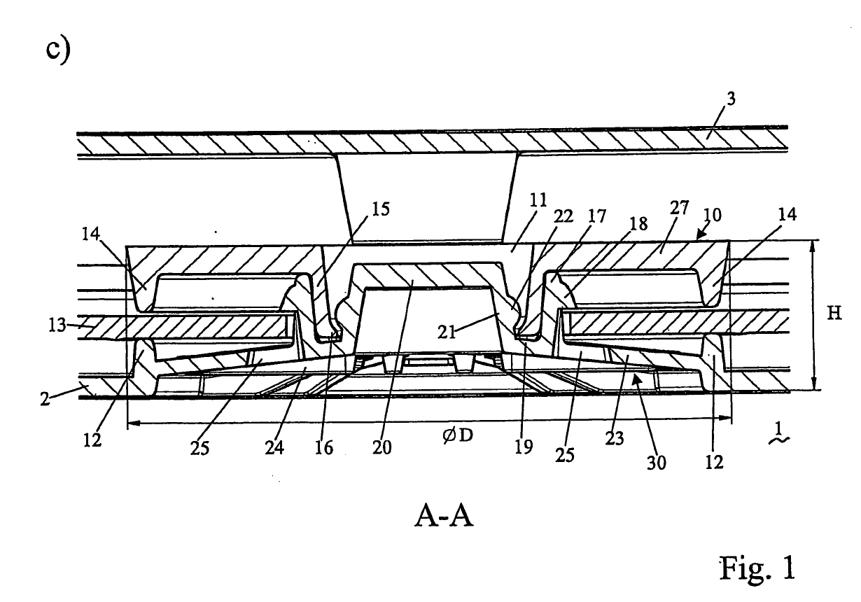

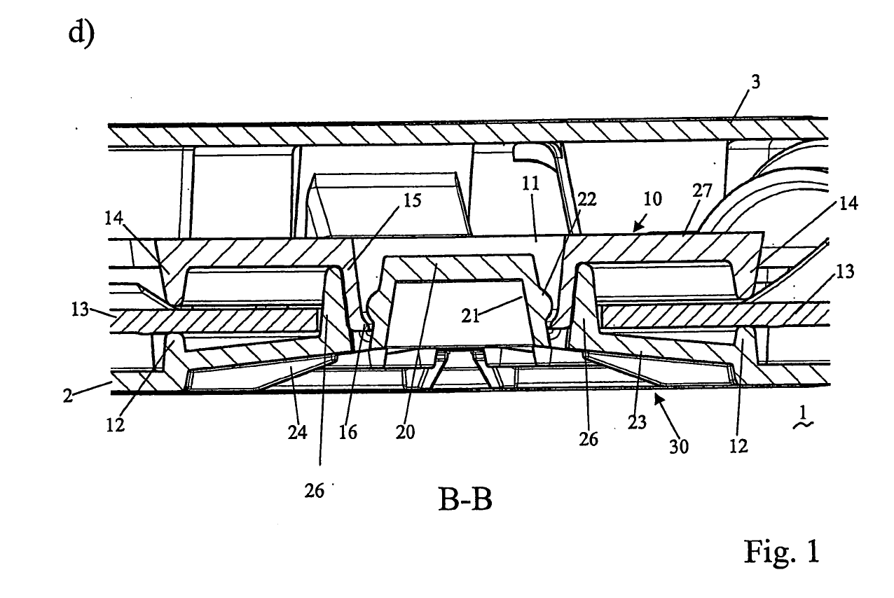

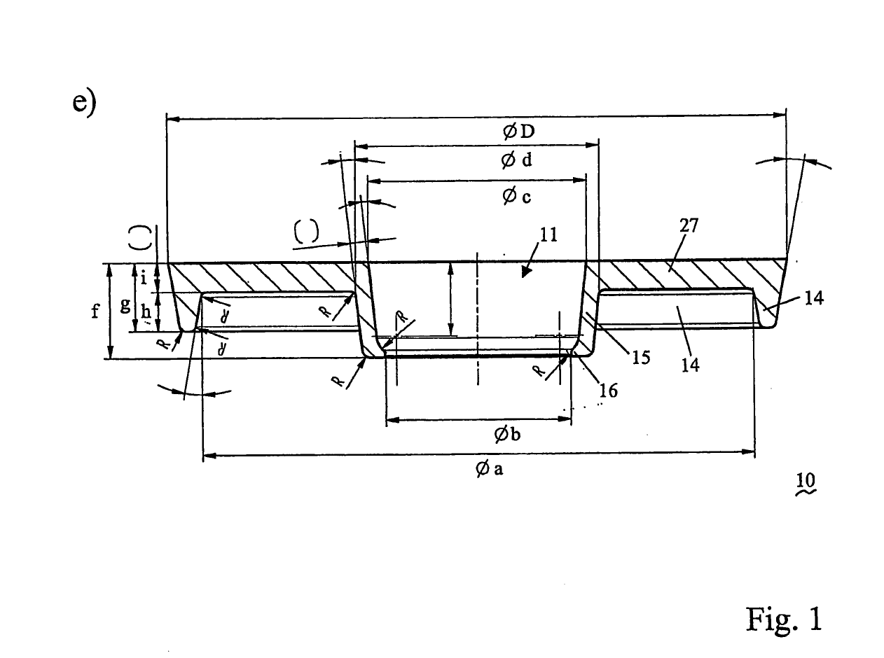

FIG. 1a) shows a plan view of a DVD box 1, in the case of which the bottom half-part 2 is represented and the lid half-part 2 has been removed for better illustration. The bottom half-part 2 and the lid half-part 2 (not represented) are connected to each other by means of a hinge 7, which typically takes the form of a thinned material transition, so that the lid half-part 2 can be swung open. To allow the DVD box 1 to be firmly closed, a latching-in mechanism 8 is arranged on the long edge that is arranged opposite the hinge 7. The bottom half-part 2 is formed in one piece and normally produced from PP, PVC or PE. Arranged in the middle is a fastening device, by means of which a DVD (not represented in FIG. 1a)) can be fastened by means of its central opening to the bottom half-part 2. This fastening device, which typically comprises at least two tongues which engage in the central opening of the data carrier, cannot be seen in FIG. 1a), since a security device 10, which is to be described in detail further below, has been placed onto this fastening device.

In order that the data carrier is also supported at the peripheral edge, on the one hand an outer supporting rib 6 is arranged, supporting the outermost edge of the data carrier, which has no data, from below, should a pressure press the data carrier from above down onto the bottom. Also arranged around the peripheral edge of the data carrier is a bead or enclosing rib 4, which is only present in segments (just like the supporting rib 6) and correspondingly has interruptions 5. This enclosing rib 4 prevents lateral displacement of the data carrier in its actual storage region. The figures that are now discussed below, FIGS. 1b)-e), are to be seen in the light of such a DVD box 1, although other forms are also possible.

FIG. 1b) shows a plan view of a security device 10 with a central opening 11. Also indicated is the rosette of securing tongues that are arranged underneath this security device 10 and are to be discussed in detail in conjunction with FIGS. 1c) and d). In particular, FIG. 1b) shows the sections A-A and B-B shown in FIGS. 1c) and d).

FIG. 1c) shows a central section, which is taken through opposite retaining tongues 17. In this case, the section is represented with an inserted data carrier 13. The bottom half-part 2 has a middle part 30, which is provided with a rosette of securing tongues 17, which engage in the central opening of the DVD 13 and thereby fasten the latter in the box. For this purpose, these securing tongues 17 are respectively provided with a retaining lug 18, which has toward the top a rounded-off form for the insertion of the data carrier, and toward the bottom are provided with a flank parallel to the inserted data carrier. The retaining tongues 17 are connected to a bearing ring 12 by means of radial, outwardly leading arms 23. The arms 23 are inclined upward at an angle from the horizontal toward the center (up to about 10°), in order that, when the retaining tongues are pressed down by means of the button 20, the retaining tongues yield inwardly toward the center and release the data carrier, and in order that they spring back again after the pressure is removed.

The bearing ring 12 is formed as an upwardly directed rib, which supports the data carrier from the underside, doing so in a region which is arranged within the data-carrying region of the data carrier. Furthermore, the retaining tongues 17 are connected to a central button 20 by means of a connecting piece 19.

The button has on the one hand an upper, typically circular or star-shaped, area 20, which is intended for being actuated with the thumb or the index finger for the removal of the data carrier. This area 20 has a conically downward-widening connecting region 21, which for its part is connected to the connecting pieces and is consequently in effective connection with the retaining tongues. To be able to ensure on the one hand sufficient stability for the securement of the data carrier and on the other hand sufficient flexibility for the removal of the data carrier, such a rosette has supporting ribs 24 on certain ones of the arms 23; in particular, there are to some extent clearances 25 directly radially outside the retaining tongues 17, and arranged so as to alternate with the retaining tongues there are advantageously, as represented in FIG. 1d), centering lugs 26, which do not have retaining lugs 18 but substantially only center the data carrier.

If the button 20 is pressed down from above, the retaining tongues 17, mounted movably by means of the arms 23, are made to tilt inward, that is to say in the radial direction; the retaining lugs 18 consequently draw back in the radial direction, and the data carrier 13 is released.

If then, as occurs in the case of a manipulation for the unauthorized removal of the data carrier described in the introduction, the wall of the lid half-part 3 is forcibly pressed from above onto the region 20, if no security device 10 is present it is possible for the data carrier to be pressed out from the securing lugs 18 and it is subsequently loose in the container.

In order to make this manipulation impossible, a security device 10 is therefore provided. This is formed as an annular disk 27, which has at its peripheral edge a downwardly directed supporting ring 14. The supporting ring 14 has substantially the same diameter as the bearing ring 12, which supports the data carrier 13 from below. At its radially inner edge, the annular disk 27 has a conically tapering engaging ring 15, which engages in the encircling groove that is available between the retaining tongues 17 and the connecting cone 21. This engaging ring 15 is provided at its lower inner edge with an encircling projection, a latching lug 16. In order then to make such a security device 10 snap onto the fastening device, the connecting cone 21 has on its outer surface means which correspond to the encircling latching lug 16 and may either be formed as an encircling groove or, as represented in FIG. 1c), as an encircling retaining rib or as a retaining bead. This retaining rib does not have to be formed in an encircling manner, it may also comprise punctiform retaining studs.

The latching lug 16 then reaches behind this retaining rib 22 and is thereby engaged in a latching manner on the middle part 30 and consequently connected to the bottom half-part. Producing the security device 10 or the bottom half-part 2 from a plastics material provides sufficient flexibility to allow the security device 10 to be removed, that is to say to allow the latching lug 16 of the security device 10 to be pulled over the retaining rib 22 by a certain force.

If, on the other hand, in the presence of such a security device 10, a pressure is exerted through the wall of the lid half-part 3 onto the central region of the data carrier from above, this pressure does not act at any point on the retaining tongues 17, but is transferred completely via the supporting ring 14 to the bearing ring 12. It is possible to combine this effect with a restriction of the mobility of the retaining tongues 17 in the radial direction, but this is not absolutely necessary.

By contrast with devices according to the prior art that provide the secure protection by restricting the mobility of the retaining tongues, no pressure is exerted on the tongues in the case of the proposed security device, even under great loading, but instead the pressure is transferred completely to the bearing ring 12. While in the case of devices according to the prior art, under some circumstances the tongues can indeed be deformed under great force, and the data carrier pressed free, this is not possible in the case of the device proposed.

FIG. 1e) shows a central section through a security device 10. The security device has a diameter D of 32 mm, an inner diameter a of 28.5 mm, a diameter of the central opening 11 at the bottom of b=9.5 mm, and a corresponding diameter at the top of c=11.2 mm. The upper outer diameter is d=12.5 mm. Advantageously, an overall height of f=about 5 mm is chosen, the overall height at the outer edge being chosen to be approximately g=3.5 mm. The height of the projection of the supporting ring 14 is chosen for example as h=2 mm and the thickness of the annular disk is chosen as i=1.5 mm.

In its simplest form, the security device 10 is formed in a circular manner. However, it is also possible for it to be of a rectangular, star-shaped or any other form, for example a polygonal form; what is important is that, on the underside, the supporting ring 14 rests at least partially congruently on the bearing ring 12. However, this does not necessarily have to be brought about by a concentric supporting ring 14, but can likewise be ensured by a star-shaped (or similar) supporting ring, which then respectively transfers the force to the bearing ring 12 at the points where they coincide.

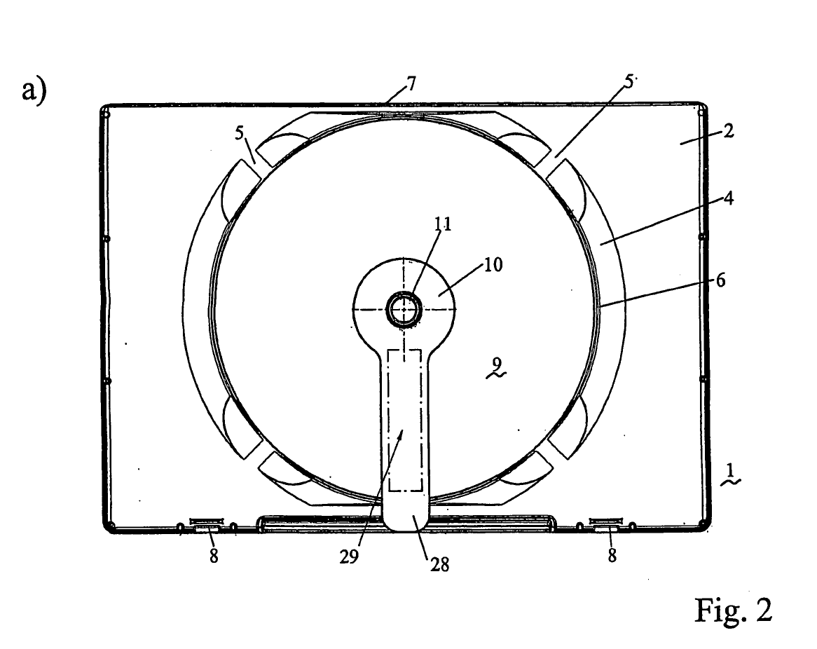

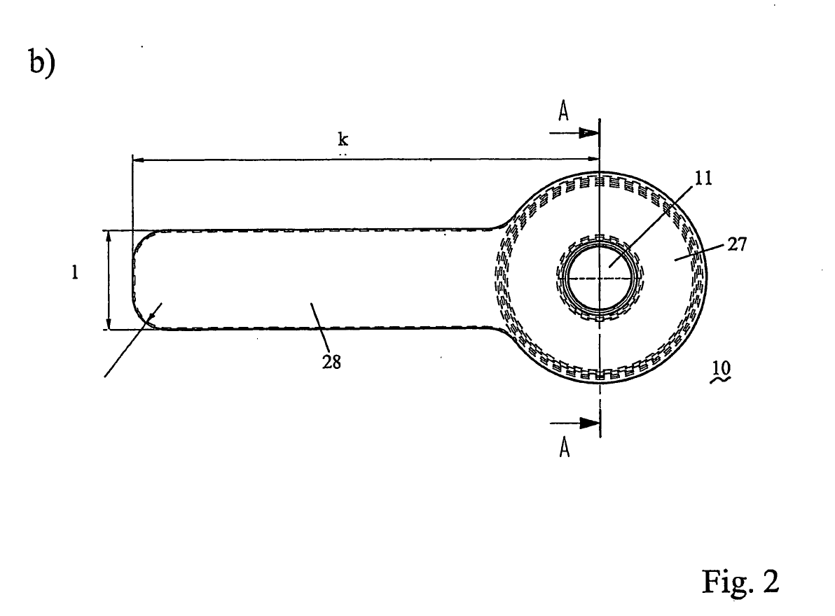

In FIG. 2, another possible way of forming the security device 10 is represented. In FIG. 2a), a plan view of such a security device is represented; it can be seen that a removal tongue 28 is additionally integrally formed. This may either extend almost, or even completely, out of the box, but it may also be made shorter than that. With preference, this removal tongue 28 is formed in a flexible manner, so that, when engaged from behind, it can be lifted off upward and the security device 10 can be easily removed. In FIG. 2b), a corresponding plan view is represented in detail; such a removal tongue may for example have a length k in the range of 70 mm and a width 1 in the range of 10 to 20 mm. Furthermore, the possibility of providing means for guarding against theft on or in such a security device is represented in FIG. 2a). For example, an RFID tag may be adhesively attached on the removal tongue 28.

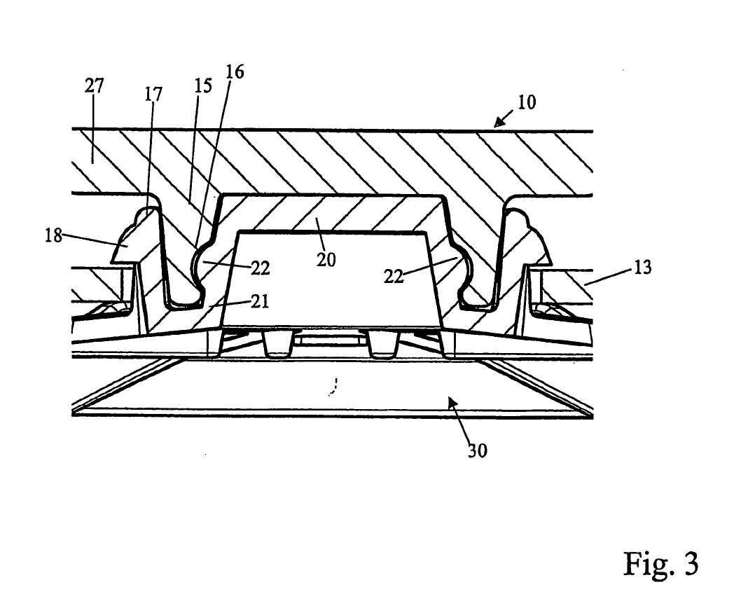

In FIG. 3, another possibility for a security device 10 is depicted in a cutout. Here, the security device does not have a central opening, and furthermore the engaging ring 15 is formed in such a way that to a certain extent it completely fills the encircling groove between the retaining tongues 17 and the connecting cone 21, and consequently the radially inward mobility of the retaining tongues 17 is additionally impossible just as it was before.

The proposed DVD box or fastening device or security device is equally suitable for DVDs and CDs of various sizes, i.e. not only with diameters of 120 mm, but also of 80 or 60 mm and also for non-circular data carriers (card formats) etc.

### LIST OF DESIGNATIONS

1 DVD box
2 bottom half-part
3 lid half-part
4 peripheral enclosing rib
5 interruptions in 4
6 outer supporting rib
7 hinge edge
8 latching-in mechanism
9 region for DVD
10 security button
11 central opening in 10
12 bearing ring on 2
13 DVD
14 supporting ring on 10
15 engaging ring on 10
16 latching lug on 15
17 retaining tongue
18 retaining lug
19 connecting piece
20 button
21 connecting cylinder/connecting cone
22 retaining rib
23 arm of 17 or 26
24 supporting rib
25 clearance
26 centering lug
27 annular disk
28 removal tongue
29 security tag, label
30 middle part
D diameter of 10
H overall height of 2 and 10
a diameter, inner
b diameter 11 (bottom)
c diameter 11 (top)
d diameter 11 (outer, top)
f overall height 10
g overall height 14
h projection 14
i thickness 27
k length of 28
l width of 28

1-27. (canceled)

28. A fastening device for at least one circular data carrier with a central opening in a cassette or box, wherein the box comprises, on a bottom part thereof, a middle part, to which at least two tongues are fastened for resiliently engaging a central opening of the data carrier, and comprising a sectional bearing ring positioned to have the data carrier rest thereon, wherein the fastening device further comprises a security device having a supporting ring, supporting rib, or supporting region, that is sectional and substantially concentric to the bearing ring and faces the data carrier, wherein the security device is fastened in the box such that when the box is closed, the security device at least partially covers a region of the tongues on an upper side of the fastening device, and wherein the supporting ring, the supporting rib, or supporting region is arranged, at least in certain regions thereof, on a side of the data carrier that is facing away from the bearing ring.

29. The fastening device as claimed in claim 28, wherein the bearing ring is in the form of an annular rib facing the data carrier from an underside thereof, wherein the annular rib has a height perpendicularly to the plane of the data carrier in the range of 1 to 4 mm.

30. The fastening device as claimed in claim 28, wherein the bearing ring is arranged radially outside the tongues and radially inside a data region of the data carrier, and wherein the bearing ring has a radius of 20-30 mm.

31. The fastening device as claimed in claim 28, wherein the data carrier is adapted to be fastened in the fastening device, wherein the security device is fitted such that it is mounted in a substantially freely rotatable manner.

32. The fastening device as claimed in claim 28, wherein the supporting ring is in the form of an annular rib facing the data carrier from an upper side thereof, wherein the annular rib has a height perpendicularly to the plane of the data carrier in the range of 1 to 4 mm.

33. The fastening device as claimed in claim 28, wherein the supporting ring is circumferential and is arranged radially outside the tongues and radially inside a data region of the data carrier, and wherein the supporting ring has a radius of 20-30 mm.

34. The fastening device as claimed in claim 28, wherein a radius of the supporting ring and the bearing ring are substantially the same.

35. The fastening device as claimed in claim 28, wherein the bearing ring is situated on a radial outer side of the middle part.

36. The fastening device as claimed in claim 35, wherein the security device is removably fastened in the box.

37. The fastening device as claimed in claim 36, wherein the security device is fastened at least indirectly to the bottom part in a region of the central opening of the data carrier.

38. The fastening device as claimed in claim 37, wherein the security device has a region in the form of a circular disc, wherein at a peripheral edge thereof the supporting ring is downwardly directed and is fastened or integrally formed, and wherein the circular disc in a central region thereof includes means for releasably fastening the security device to the middle part.

39. The fastening device as claimed in claim 38, further comprising a ring of tongues having radially outwardly directed retaining lugs, and wherein the tongues are adapted to tilt away radially inwardly by means of a central button for the removal of the data carrier, and wherein the means for releasably fastening the security device to the middle part are in releasable engagement with portions of the tongues and/or of the button.

40. The fastening device as claimed in claim 39, wherein the means for releasably fastening the security device to the middle part include a downwardly directed, cylindrical or conical region, adapted to click in place with portions of the tongues and/or of the button by means of a tongue and groove or channel and rib or stud and socket, wherein the security device includes a central opening within this cylindrical or conical region.

41. The fastening device as claimed in claim 40, wherein the button has a substantially circular region adapted to be actuated by a thumb, and a cylindrical or conical, downwardly directed connecting region, wherein a lower edge thereof is connected at least indirectly to the retaining lugs, and in that the connecting region has on its radially outwardly directed surface a retaining rib, retaining studs, or a retaining groove, and the security device has on its cylindrical or conical region corresponding, radially inwardly directed latching means the form of a substantially encircling retaining rib, retaining studs and/or a retaining groove.

42. The fastening device as claimed in claim 28, wherein the security device has at least one removal aid.

43. The fastening device as claimed in claim 28, wherein the security device comprises a region in the form of a circular disc with a diameter in the range of 15-40 mm.

44. The fastening device as claimed in claim 28, wherein the security device is produced in one piece from polystyrene, polypropylene or polycarbonate, and wherein, the box is produced from polystyrene, polypropylene or polycarbonate.

45. The fastening device as claimed in claim 28, wherein the security device is produced in one piece from polypropylene, and wherein the box is produced at least in the region of the fastening device from polypropylene.

46. The fastening device as claimed in claim 28, wherein the security device is provided with an antitheft means.

47. A security device for a fastening device having at least one circular data carrier with a central opening in a cassette or box, wherein the box comprises, on a bottom part thereof, a middle part, to which at least two tongues are fastened for resiliently engaging a central opening of the data carrier, and comprising a sectional bearing ring, positioned to have the data carrier rest thereon, wherein the security device has a region in the form of a circular disc with a diameter in the range of 15-40 mm, wherein at a peripheral edge thereof a downwardly directed, supporting ring having a height in the range of 1-4 mm is integrally formed, and wherein the supporting ring has in a central region a downwardly directed, cylindrical or conical, region with a height in the range of 2-6 mm, which is adapted to click in place with portions of the tongues by means of a tongue and groove or channel and rib or stud and socket.

48. The security device as claimed in claim 47, further comprising a central opening, through which a button of the fastening device passes.

49. The security device as claimed in claim 47, wherein the security device is produced in one piece from polystyrene, polypropylene or polycarbonate, with preference from polypropylene.

50. The security device as claimed in claim 47, wherein a circumferential, radially inwardly directed latching lug is integrally formed on the conically downwardly tapering region, at a lower edge thereof.

51. The security device as claimed in claim 47, wherein a removal aid in the form of at least one removal tongue is provided, wherein the removal tongue is in a flexible form and has a length in the range of 10-80 mm.

52. A box for a fastening device having at least one circular data carrier with a central opening in a cassette or box, wherein the box comprises, on a bottom part thereof, a middle part, to which at least two tongues are fastened for resiliently engaging a central opening of the data carrier, and comprising a sectional bearing ring positioned to have the data carrier rest thereon, wherein the box includes a ring of tongues arranged on a bottom half-part of the box and is unitary therewith, wherein the tongues are adapted to fasten the data carrier by means of radially outwardly directed retaining lugs, and wherein the tongues are adapted to tilt away radially inwardly by means of a central button for the removal of the data carrier, and wherein the button has a substantially circular region for actuating by a thumb, and a cylindrical or conical, downwardly directed connecting region, wherein the lower edge thereof is connected at least indirectly to the retaining lugs, and wherein the connecting region has on a radially outwardly directed surface thereof a retaining rib or retaining groove or retaining studs and sockets.

53. The box as claimed in claim 52, wherein a circumferential retaining rib is arranged on a radially outer surface of the connecting region.
